(19) United States
(12) Patent Application Publication
(10) Pub. No.: US 2005/0256761 A1
(43) Pub. Date: Nov. 17, 2005

(54) Packaged consumer products and services and method thereof communicating a company's products and corporate values

(75) Inventors: Lee James Coomber, Kingston-On-Thames (GB); Miles Hugh Newlyn, London (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 11/032,606

(22) Filed: Jan. 10, 2005

(30) Foreign Application Priority Data
May 11, 2004 (GB) 0410444.4

(51) Int. Cl. G06F 17/60

(52) U.S. Cl. 705/13

(57) ABSTRACT

A consumable article and a method for broadcasting a company's products and communicating corporate values is disclosed which includes providing a logo constructed as an alphabet letter formed from at least three groups of symbols, a first of the three groups representing one product category, a second of the three groups representing another product category, and a third of the three groups representing corporate values. The article bears the logo applied to a label on a package housing a consumable material.

### BACKGROUND OF THE INVENTION

1. Field of the Invention

The invention concerns packaged consumer products and services and a method which communicates a company's product areas and emphasizes corporate values.

2. The Relevant Art

Marks of origin appear on essentially all packaged goods and most services. These marks are known as brands. Besides origin, brands convey a message of a product's level of performance.

Some marks are also corporate logos. These identify the corporate source. Very few corporate logos deliver a message of a company's products in conjunction with the principles to which the company is dedicated. Improved methods are needed to communicate these messages.

### SUMMARY OF THE INVENTION

A method is provided for broadcasting a company's products or services and communicating corporate values which includes:
providing a logo constructed as an alphabet letter from at least three groups of symbols, a first of the three groups representing one product category, a second of the three groups representing another product category, and a third of the three group representing corporate values; and
applying the logo to a label of a consumable product.

Also provided is a consumable article which includes:
a package housing a consumable material; and
a logo placed on the package, the logo broadcasting a company's products one of which is the consummable material and communicating corporate values, the logo constructed of an alphabet letter formed from at least three groups of symbols, a first of the three groups representing one product category, a second of the three groups representing another product category, and a third of the three groups representing corporate values.

### BRIEF DESCRIPTION OF THE DRAWING

Various features and aspects of the present invention will become more readily evident from consideration of the following drawing in which:

FIG. 1 is a first embodiment of a logo formed as an alphabet letter “U”;

FIG. 2a is a shape drawn as a palm tree to signify palm oil usable in margarine and spread foods;

FIG. 2b is a shape drawn as a swirl to signify tomato and barbecue sauces and salad dressing foods;

FIG. 2c is a shape of a spoon drawn to signify spoonable foods such as mayonnaise and yogurt;

FIG. 2d is a shape drawn as a steaming bowl to signify ready-to-eat meals and soups;

FIG. 2e is a shape drawn as a vegetable to signify spices and flavors;

FIG. 2f is a shape drawn as a fish to signify fish products;

FIG. 2g is a shape drawn as a cone to signify ice cream;

FIG. 2h is a shape drawn as a plant to signify tea and tea containing beverages;

FIG. 2i is a shape drawn as water transitioning to an ice crystal signifying frozen foods;

FIG. 2j is a shape drawn as a heart to signify healthy products such as olive oil and spreads with cholesterol lowering additives;

FIG. 3a is a shape drawn as a hand to signify body care products such as creams and lotions;

FIG. 3b is a shape drawn as a hair tress to signify shampoos, hair colorants and hair conditioners;

FIG. 3c is a shape drawn as a water wave in a washing machine to signify laundry detergents;

FIG. 3d is a shape drawn as particles to signify tableware and household cleansers;

FIG. 3e is a shape drawn as a jar to signify cosmetics;

FIG. 3f is a shape drawn as a shirt to signify laundry and fabric softeners;

FIG. 3g is a shape drawn as lips to signify toothpaste, toothbrushes and mouthwash;

FIG. 4a is a corporate value symbol of sparkle representing commitment to renewable energy sources;

FIG. 4b is a corporate value symbol of a bird representing commitment to clean air;

FIG. 4c is a corporate value drawn as arrows representing commitment to using sustainable resources;

FIG. 4d is a corporate value drawn as a bee representing commitment to bio-diversity and environmental initiatives;

FIG. 4e is a corporate symbol drawn as liquid droplets representing commitment to clean water;

FIG. 4f is a corporate symbol drawn as a sunburst representing commitment to all that reflects human vitality; and

FIG. 4g is a corporate value symbol drawn as a DNA double helix representing commitment to enhancing life through biotechnology advances.

### DETAILED DESCRIPTION OF THE INVENTION

Now there is described in more detail the method for communicating to the public a company's products and corporate values. In a first aspect of the present invention, there is provided a logo based upon an outline of an alphabet letter. Although not restricted to other alphabets, preferred are letters found in the Romance languages. These may be the letters A, B, C, D, E, F, G, H, I, J, K, L, M, N, O, P, Q, R, S, T, U, V, W, X, Y and Z, and mixtures thereof. The alphabet letter may be in lower or upper case or script form so long as it is recognizable as an alphabet letter.

According to a further aspect of the invention, the alphabet letter must be formed from at least three groups of symbols. A first of the three groups should represent at least one product category sold by the company. A second of the three groups should represent another product category sold by the company. Finally, a third of the three groups should represent at least one corporate value. It is to be understood that more than one shape is preferably present to represent each of the three groups of symbols. For instance, there can be anywhere from 2 to 50, preferably from 3 to 10 individual shapes related to each of the one product category, another product category and corporate value groups of symbols.

Once the logo is formed, it can be placed on outer packaging housing a consumable material, the total forming a consumable article.

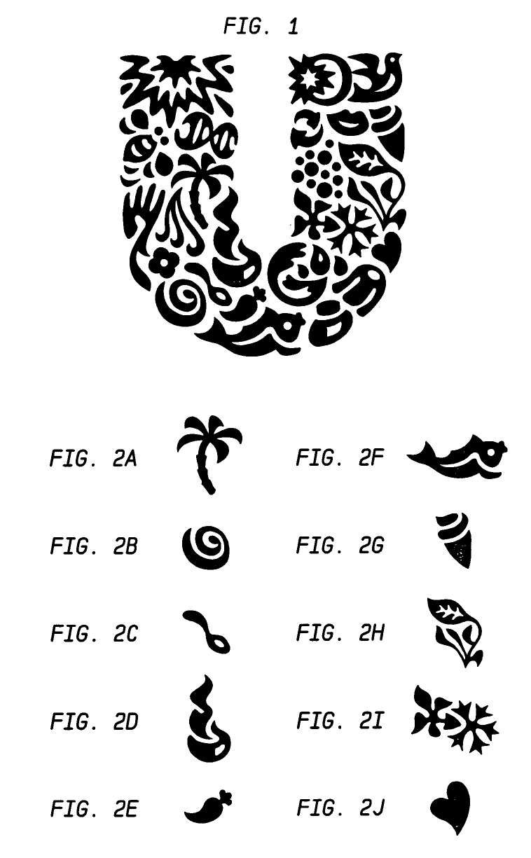

Illustrative of the present invention is FIG. 1 displaying a logo in macro outlining the letter “U”. This logo is formed from a set of three symbols representing corporate values, the food product category and personal care or home care product category supplied by the corporation.

FIG. 2a is a palm tree. Palm oil is derived from that tree which is a major ingredient of margarines and edible spreads. Illustrative foods are those appearing under the trademarks Becel®, Rama®, Promise®, Country Crock®, I Can't Believe It's Not Butter®, Imperial® and Flora®. FIG. 2b is a swirl for depicting sauces and salad dressings. Typical products are tomato and barbecue sauces and salad dressings. These foods are sold under the trademarks Ragu®, Bertolli®, Hellman's® and Wishbone®.

FIG. 2c is a food symbol drawn as a spoon. This represents spoonable products such as baking fats and mayonnaise. These foods are sold under trademarks such as Hellman's®. FIG. 2d is a food symbol illustrated as aroma emanating from a bowl. This symbol represents ready-to-eat meals and soups. Food products of this type are available under the trademark of Lipton® Cup-of-Soup® and Knorr®. FIG. 2e is a food product category symbol for spice and flavors. Illustrative products include bouillon and spice powders which are available under trademarks such as Knorr® and Lawry's®.

FIG. 2f is a food product symbol illustrated as a fish. This represents frozen fish sticks and fillets.

FIG. 2g is a food product symbol drawn as an ice cream cone representing ice cream confectioneries. These are marketed under such trademarks as Breyers®, Good Humor®, Magnum®, Cornetto®, Popsicle®, Klondike® and Wall's® ice creams. FIG. 2h is a food product symbol illustrated as a tea leaf representative of tea beverages. These are available in the marketplace under the Lipton® trademark. FIG. 2i is a food category product illustrated as water transitioning to an ice crystal. This symbol represents a variety of frozen foods. Typical products in this category may be found under the trademarks of Birds Eye®, Iglo® and Findus®. FIG. 2j is a food product symbol illustrated by a heart representing health and wellness. These foods include cholesterol lowering margarines sold under such trademarks as Becel® Pro-Active® and Take Control®. Bertolli® Olive Oils may also fall under this symbol.

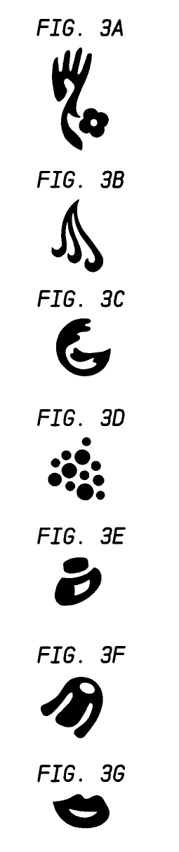

A second of the three groups of symbols requiring presence in the alphabet letter are at least one in another product category such as home care or personal care products. FIG. 3a is a personal care product symbol drawn as a hand representing such products as skin creams and lotions. These are available in the marketplace under such trademarks as Dove®, Vaseline® Intensive Care Lotion® Pond's®, and Fair & Lovely®. FIG. 3b is a personal care product symbol drawn as hair representing shampoos, conditioners and hair colorants. These products may be found in the market under the trademarks of Sunsilk®, Dove®, Thermasilk®, Suave®, Organics®, Rave® and Lux®.

FIG. 3c is a home care product symbol drawn as a wave representing laundry detergents. These are represented in the market by trademarks such as Omo®, all®, Wisk®, Persil® and Surf®. FIG. 3d is a home care product symbol drawn as particles indicating bubbling and fizzing. The symbol represents hard surface and toilet bowl cleaners as well as tableware detergents. These are typically found in the marketplace under trademarks such as Sunlight®, Domestos® and Cif®. FIG. 3f is a home care symbol drawn as a garment representing fabric conditioning. These are available in the market under trademarks such as Snuggle®, Comfort® and all®.

FIG. 3e represents a personal care symbol drawn as a jar representing cosmetics. These cosmetics may be cold creams and color cosmetics (e.g. facial foundations, mascara and eyeshadow). They are typically available in the market under trademarks such as Pond's®, Dove® and Calvin Klein Cosmetics®. FIG. 3g is a personal care symbol drawn as lips signifying oral care products including toothpaste, toothbrushes and mouthwash. Typically these are available in the market under trademarks such as Mentadent®, Close-Up®, Pepsodent® and Signal®.

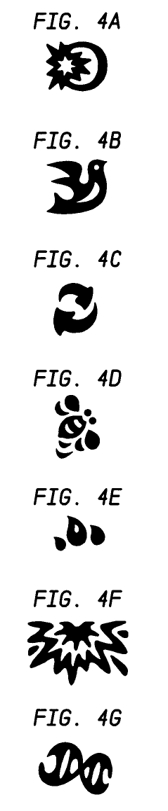

Corporate values are represented by a third group of symbols. FIG. 4a is a symbol drawn as a sparkle of energy representing the corporate value of commitment to renewable energy sources. FIG. 4b is a corporate value symbol drawn as a bird representing commitment to clean air. FIG. 4c is a corporate value drawn as returning arrows representing commitment to sustainability of resources. Not only is this intended for recycling of packaging but also to mariculture (fish farming) and use of vegetable sources in place of non-renewable petroleum based ingredients.

FIG. 4d is a corporate value symbol drawn as a bee. Biodiversity and environment is represented by the bee. This insect symbolizes both environmental challenges and opportunities. FIG. 4e is a corporate value symbol drawn as a liquid to represent commitment to clean water and purity. FIG. 4f is a corporate value symbol drawn as a sunburst. It represents commitment to bring vitality to the lives of consumers. FIG. 4g is a corporate value symbol drawn as an idealized DNA double helix intended to represent commitment to the bio-sciences as a key to providing a healthy life. FIG. 4f drawn as a sunburst is the biggest ingredient of life, and DNA represented by FIG. 4g is the smallest.

Another aspect of the present invention is to provide consumable articles delivering a corporate message. These articles are consumable materials which may be found in the marketplace as foods, personal care or home care consumables. The products are packaged in plastic, paper or glass containers with labels affixed to the packaging. A trademark will be found on the packaging for the consumable article. In addition to the trademark, there is proposed a logo such as illustrated in FIG. 1 comprised of an alphabet letter. The letter is formed of ten shapes (FIG. 2a-2j) representing a variety of symbols for food products. A second set of seven shapes (FIG. 3a-3g) represent a combined category of personal care and home care type products. Still a third set of seven symbols representing corporate values (FIG. 4a-4g) join the food and personal and home care symbols. The total of twenty-four symbols serve as building blocks for the alphabet letter shown in FIG. 1 as a “U”.

Not all corporate names are known to consumers, although corporate brands may have been around for a century. People might not easily connect the corporation with its brands. Most do not know what the corporation stands for and might see the company as yet another multinational. The purpose of the communication logo is to demonstrate to consumers the corporation is not a remote holding company. It is a company dedicated to great brands that help people look good, feel good, and get more out of life. At the same time, the logo represents a company that tries to act responsibly towards its communities and the environment. The aim is to add vitality to life.

1. A method for broadcasting a company's products or services and communicating corporate values comprising:
providing a logo constructed as an alphabet letter from at least three groups of symbols, a first of the three groups representing one product category, a second of the three groups representing another product category, and a third of the three group representing corporate values; and
applying the logo to a label of a consumable product.

2. The method according to claim 1 in which the first of the three groups represents one product category which is food.

3. The method according to claim 1 wherein the second of the three groups represents another product category which is personal care or home care products.

4. The method according to claim 1 wherein the alphabet letter is a single letter used in Romance language alphabets.

5. The method according to claim 1 wherein the third of the three groups represents corporate values, the values being selected from the group consisting of advocating renewable energy, bio-diversity, clean air, clean water and combinations thereof.

6. The method according to claim 1 wherein the first of the three groups has at least two shapes representing the one product category which is a food, and the second of the three groups has at least two shapes representing another product category which is a personal care or home care material.

7. The method according to claim 1 wherein the first of the three groups comprises from 2 to 50 shapes selected from the group consisting of a drawing identifiable as a palm tree, a spoon, a fish, an ice cream cone and combinations thereof.

8. The method according to claim 1 wherein the second of the three groups comprises from 2 to 50 shapes selected from the group consisting of a drawing identifiable as a hand, hair, a jar, a garment, lips and combinations thereof.

9. A consumable article comprising:
a package housing a consumable material; and
a logo placed on the package, the logo broadcasting a company's products one of which is the consumable material and communicating corporate values, the logo constructed of an alphabet letter formed from at least three groups of symbols, a first of the three groups representing one product category, a second of the three groups representing another product category, and a third of the three groups representing corporate values.

10. A consumable article according to claim 9 wherein the first of the three groups represents one product category which is food, the second of the three groups represents another product category which is personal care or home care products, and the third of the three groups represents corporate values which are selected from the group consisting of advocating renewable energy, bio-diversity, clean air, clean water and combinations thereof.
